(19) United States
(12) Patent Application Publication
(10) Pub. No.: US 2006/0098432 A1
(43) Pub. Date: May 11, 2006

(54) Light source for image writing device, and production method for light source

(76) Inventors: Tetsuroh Nakamura, Takaraduka-shi (JP); Ken-ichi Masumoto, Hirakata-shi (JP); Yuji Toyomura, Fukuoka-shi (JP); Takafumi Hamano, Chikushi-gun (JP); Akira Gyotoku, Miyaki-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/533,132

(22) PCT Filed: Oct. 28, 2003
(86) PCT No.: PCT/JP03/13799

§ 371 Date: Oct. 11, 2005

(30) Foreign Application Priority Data
Oct. 30, 2002 (JP) 2002-315651

(51) Int. Cl. F21V 1/00

(52) U.S. Cl. 362/235; 362/240

(57) ABSTRACT

A light source for an image writing apparatus which can reduce the number of units without sacrifice in sufficient accuracy, and does not need an accurate alignment, and production method for the light source. The light source for the image writing apparatus forms an image by light emitted from light emitting elements provided on a specific substrate onto a photosensitive drum, wherein light emitting elements are disposed in a zigzag manner on one sheet of the substrate.

### TECHNICAL FIELD

The present invention relates to a light source for an image writing apparatus and a production method for the light source.

### BACKGROUND ART

An electronic photography (laser) type of printer employs a light source 903 as shown in FIG. 10, in order to form an image on a photosensitive drum. The light source 903 includes a number of light emitting elements 902 that are disposed on a substrate 901 extended to the main-scanning direction. A typical light emitting element 902 is a Light Emitting Diode (LED). In the light source 903 as shown in FIG. 11, the light emitting elements 902 are disposed on positions facing a photosensitive drum 1001 over a light transmitting means 904. Rays of light emitted from the light transmitting elements 902 are focused on the photosensitive drum 1001 through the light transmitting means 904 included in the light source, and form a latent image thereon. Unlike the liquid crystal display or the like, the light source employed by the printer requires the focus adjusting to form an image. Accordingly, in order that the light source 903 accurately forms the latent image on the photosensitive drum 1001, the angle aperture of the light transmitting means 904 is diminished so as to deepen the focal depth formed by the light transmitting means 904.

Now, in these days, the laser printer is demanded so as to be able to perform the high resolution printing. To make the printer perform such high resolution printing, more light emitting elements may be disposed in the main-scanning direction. However, for example, in case of LED, in particular, from a point of view regarding the structure, a distance between the light emitting elements cannot be diminished less than a specific value. Therefore, it limits the number of the light emitting elements to be disposed per unit of length in the main-scanning direction.

To solve the above-mentioned problem, the image writing apparatus employs a light source 1109 with a structure shown in FIG. 12, for example. That is to say, light emitting elements 1103 are aligned in the main scanning direction 1111 on a substrate 1101, which forms a unit. Likewise, light emitting elements 1104 are aligned on a substrate 1102, which forms a unit. Each distance between the light emitting elements 1103 on the substrate 1101 is the same as that between the light emitting elements 1104 on the substrate 1102. But, when respective ends of the substrates 1101 and 1102 are aligned, the light emitting elements 1103 and 1104 are disposed in a zigzag manner. The term “in a zigzag manner” shows a relation between a line of light emitting elements disposed in the main scanning direction and another line of light emitting elements disposed in the main scanning direction in a same manner. That is to say, when the above-mentioned two substrates are disposed as a LED unit 1110, a plane view of the light emitting elements shows a zigzag structure.

Like the LED unit 1110 as above, a light transmitting means 1105 is provided with respective single lenses 1107 corresponding to the light emitting element 1103, and a light transmitting means 1106 is provided with respective single lenses 1108 in the same way. In such case, each single lens 1107 must correspond to each light emitting element 1103, as well as each single lens 1108 to each light emitting element 1104. That is to say, like the relation between the light emitting elements 1103 and the light emitting elements 1104, the relation between respective single lenses 1107 and 1109 shows a zigzag structure. Accordingly, the light transmitting means 1105 is a unit separated from the light transmitting means 1106.

Since a set of the light transmitting means 1105 and 1106, and the substrates 1101 and 1102 forms a light source 1109 as mentioned above, the light source 1109 has the resolution in the main scanning direction 1111 twice as much as the resolution of the light source formed only by the light transmitting means 1105 and the substrate 1101.

However, there are some troubles in the production of the light source 1109, which is extremely difficult more than that the light source including the light transmitting means 1105 and substrate 1101 only, and the production cost increases more. That is to say, the production of the light source 1109 needs the accurate alignment for the light emitting elements 1103 and 1104, whereby the high resolution can be obtained. A size of one light emitting element and a distance between light emitting elements are from a dozen or so microns to several dozens. Accordingly, at aligning the substrate 1101 and 1102 while keeping the positioning relation, the accuracy is required as same as above. Likewise, the positioning of the light transmitting means 1105 and 1106 requires the same accuracy. The positioning of the light transmitting means and the substrate requires the accuracy, too. In particular, for instance, if the distance between the light transmitting means 1105 and the substrate 1101 is different from the distance between the light transmitting mans 1106 and the substrate 1102, respective focal depth are not the same. In result, a latent image on a photosensitive drum becomes unclear, and it brings the circumstances inimical to the picture quality.

As mentioned above, since the light source that makes it possible to print in the high resolution requires the accuracy per unit of micron regarding each unit position, the production is very difficult. And the light source includes a plurality of units, which makes the production more difficult.

The above description relates that the light source 1109 consists of four units (the light transmitting means 1105 and 1106, and the substrates 1101 and 1102), but the positions of the single lenses of the light transmitting means 1105 are slightly different from those of the light transmitting means 1106. Those light transmitting means 1105 and 1106 must be produced as a different unit. Likewise, the substrate 1101 on which the light emitting elements are disposed is a different unit from the substrate 1102 on which the light emitting elements are disposed in the same manner. Each assembly must be produced separately on different production lines. This causes the problem that the production cost increases.

In addition, when the LED unit 1110 assembles in zigzag way using two substrates 1101 and 1102 on which the light emitting elements are formed respectively, the structure shows an inevitable feature that the distance between the light emitting elements 1104 and 1103 on different substrates is larger than the distance between the light emitting elements 1104 and 1104 on the same substrate. This causes a time delay, that is to say, a waiting status is generated corresponding to the above-mentioned distance during the period after a line data inputted to each light emitting element on the substrate 1101 forms a latent image till a next line data is inputted to each light emitting element on the substrate 1102. The longer the distance is, the more the waiting status is prolonged. That is to say, as the distance became large, it is necessary to retain a plurality of line data. This results in the necessity of a large amount of buffers.

The invention has objects to provide a light source of the image writing apparatus, the light source that can reduce the number of units without sacrifice the sufficient accuracy, and does not need an accurate alignment, and also provide the production method of the light source.

### DISCLOSURE OF INVENTION

To achieve the above-mentioned objects, the invention employs flowing means. That is to say, the invention is suggested based on an assumption that a light source for an image writing apparatus for focusing light emitted from light emitting elements provided on a specific substrate onto a photosensitive drum and forming an image thereon. The light emitting elements are disposed on the substrate in zigzag manner. The light emitting element may consist of an organic electro luminescence.

The abovementioned structure can resolve the problem that each element cannot be disposed closer because of the structural feature. Simultaneously, it can resolve the problem regarding the indispensable steps in the prior art, that is, the accurate alignment for the light transmitting means, and the alignment for the light emitting elements. In result, the invention can provide the light source that can perform the printing with the high resolution.

Additionally, the substrate may be a light transmitting means for focusing light emitted from the light emitting elements onto the photosensitive drum and forming an image thereon, and the light transmitting means may be formed on an opposite surface to the light emitting elements of the substrate. And the light transmitting means may be a lens alley including a plurality of single lenses.

Moreover, one of the light emitting elements may correspond to one of the single lenses, or one of the light emitting elements may correspond to a plurality of the single lenses.

The light source for the image writing apparatus can be produced according to the steps of forming a transparent electrode layer directly on a specific substrate; forming the transparent electrode layer into a plurality of transparent electrodes with a zigzag structure by means of a specific patterning processing; forming a light emitting layer consisting of an organic electro luminescence on the respective transparent electrodes with the zigzag structure; and, forming a metal electrode layer on the light emitting layer.

### BRIEF DESCRIPTION OF DRAWINGS

FIG. 1 is a schematic block view of an image writing apparatus.

FIG. 2 is a sectional enlarged view of an image writing apparatus.

FIG. 3 is a schematic view of a light source in Embodiment 1 of the invention.

FIG. 4 is a schematic block view of a light emitting element.

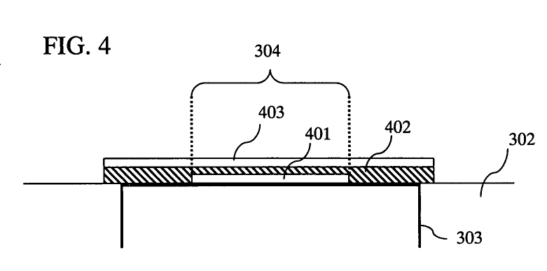

FIG. 5 is a schematic view of a light source for the image transmission.

FIG. 6 is a schematic block view of a light source in Embodiment 3.

FIG. 7 is a schematic block view of a light transmitting means in Embodiment 3.

FIG. 8 is a schematic view of a light source for the image transmission in Embodiment 3.

FIG. 9 is a cross sectional schematic view of a light source for the image transmission.

FIG. 10 is a diagram showing a conventional light source.

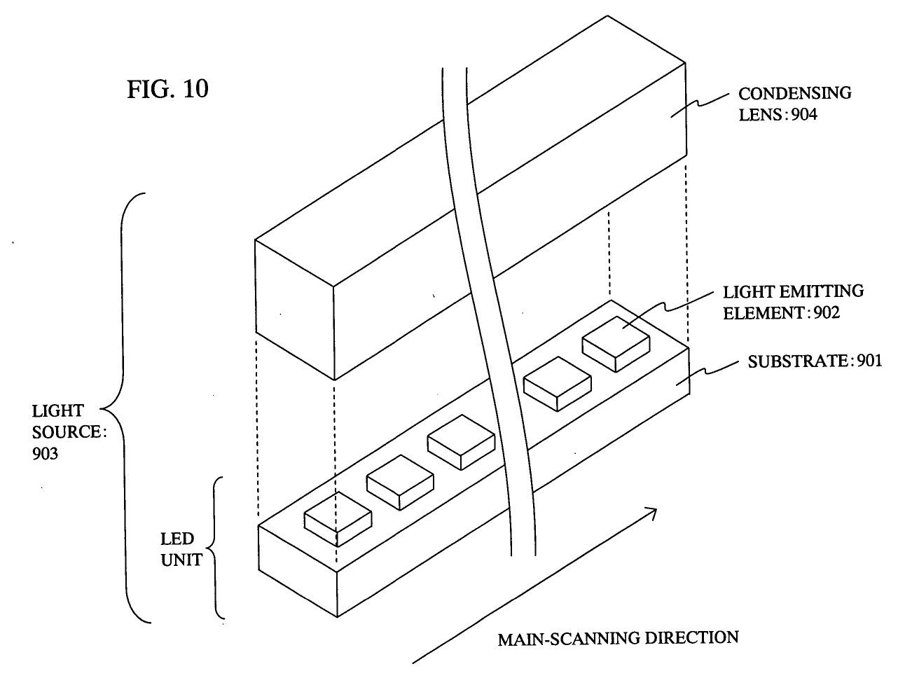

FIG. 11 is a diagram showing the positioning relation between a conventional light source and a photosensitive drum.

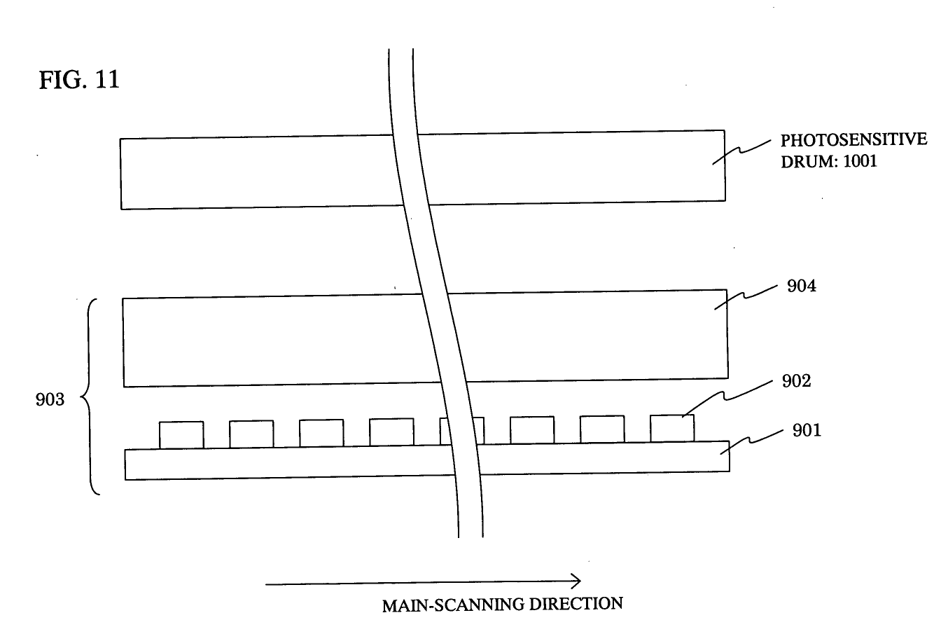

FIG. 12 is a diagram showing each unit of a conventional light source.

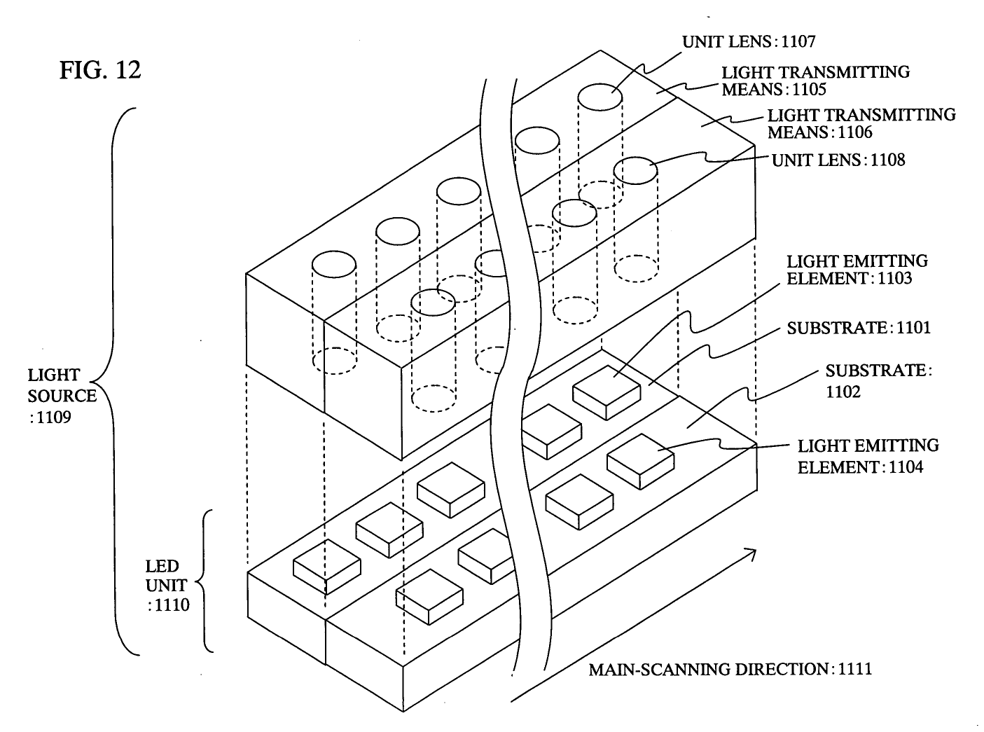

### BEST MODE FOR CARRYING OUT THE INVENTION

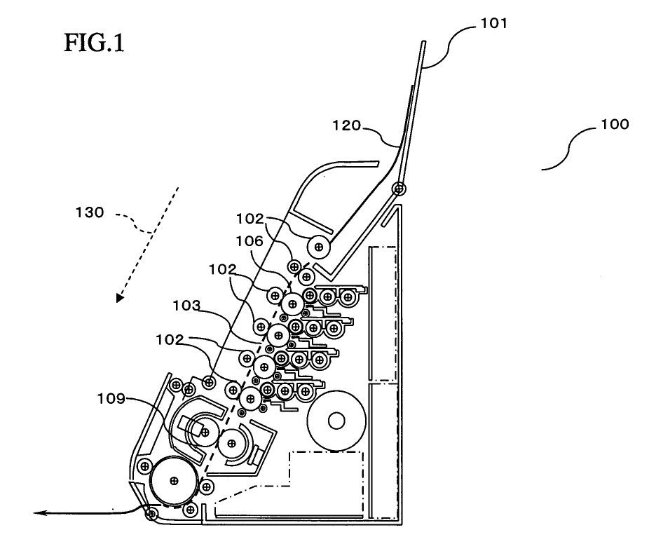

A light source 200 for the image writing apparatus in the invention is applied to the color laser printer 100 (which is called a “printer 100” simply) as shown in FIG. 1. The general printing process by the printer 100 is as follows.

A recording paper 120 put on a tray 101 is forwarded to a carrying route 103 within the printer 100 by a carrying roller 102. At the same time of carrying the recording paper 120, a visible image is formed on a photosensitive drum 106.

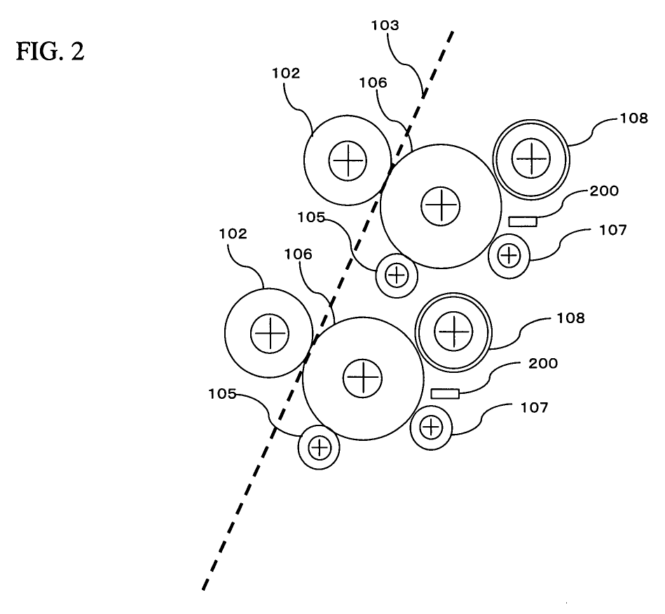

The process of forming the visible image is performed as follows; first, a discharger 105 shown in FIG. 2 eliminates a latent image previously formed on the photosensitive drum 106, a charging unit 107 charges the entire photosensitive drum with the electricity. Next, writing light emitted from the light source 200 forms another latent image on the photosensitive drum 106, and lastly, a developing processor 108 forms a visible image by adhering toner to the photosensitive drum 106 on which the latent image is formed.

The printer 100 is provided with 4 sets of the discharger 105, the photosensitive drum 106, the charging unit 107, the light source 200, and the developing processor 108, in order to perform the color printing using 4 colors of toner, Y(yellow), M(magenta), C(cyan), and B(black).

The visible images formed on each photosensitive drum are transcribed on the recording paper along the way of the carrying route 103, and in addition, a fixing unit 109 fixes the visible images thereon. After that, the recording paper is outputted from the printer.

Besides, in FIG. 1, a vertical direction to the surface of the recording paper is defined as the main scanning direction 130, and the direction in which the recording paper is carried is defined as the sub scanning direction.

The light source 200 for the image writing apparatus in the invention, which is used to the above-mentioned light source 200, is configured as described hereinafter.

### EMBODIMENT 1

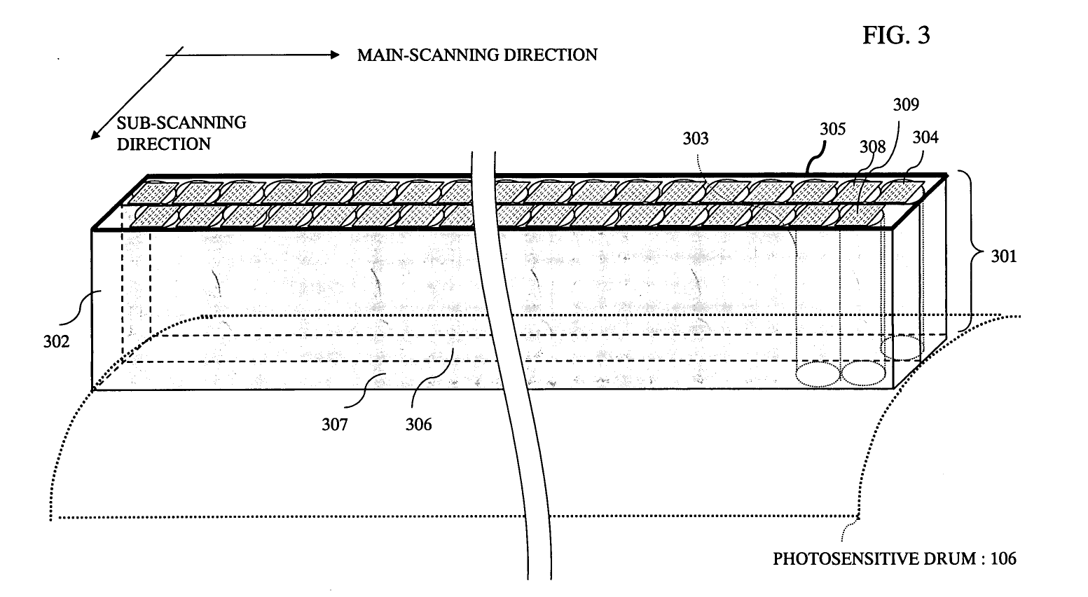

The light source 200 (light source 301 in FIG. 3) in the invention is provided with a light transmitting means 302 and light transmitting elements 304. The light transmitting means 302 is to form the latent image accurately on the photosensitive drum, as described above. Besides, the light transmitting means 302 in this embodiment is a lens alley structure. That is to say, the light transmitting means 302 is formed by bundling up a plurality of single lenses 303 with the directivity and unifying the plurality of single lenses 303 of which gaps are filled with the shading resin and so on. However, the light transmitting means 302 may be formed by combining a light transmitting means 306 provided with a line of single lenses and a light transmitting means 307 provided with a line of single lenses. As an example of the single lens, a fiber lens or a rod lens can be taken. And as the fiber lens, a step-index fiber lens or a graded-index fiber lens is available.

In the light transmitting means thus combined, the single lens included in the light transmitting means 305 and the single lens included in the light transmitting means 307 must be combined alternately (the zigzag structure). Like the conventional way, the two light transmitting means must be combined in high accuracy. However, the zigzag structure can be carried out easily by creating a two-tier of the cylindrical-shaped single lenses due to the shape of the single lens, the cylindrical shape. But under such structure, the light emitting element one-on-one corresponding to the single lens gets closer to another due to the shape of single lens, and this causes a heat trouble and a driver trouble remarkably. The solution for the troubles will be described hereinafter.

The following description relates to the steps for forming the light emitting element 304 on the light transmitting means 302 thus formed.

All over an opening surface of the light transmitting means 302 (a whole upper surfaces of the single lens 303), a transparent electrode layer such as Indium-Tin Oxide (ITO) electrode, which is a material of the transparent electrode element, is formed by the application, or the like. By such forming step, the transparent electrode layer 401 is adhered to the light transmitting means 302.

Next, a portion on the light transmitting means 302 that must emit light is an upper portion of each single lens 303 in this embodiment, and only such portion is masked by a shading film. And then, the opening surface is subjected to the photolithography processing such as the exposure, the development, and etc., which is the patterning processing. The patterning processing removes the transparent electrode layer from the other portions without the masking, and the masked portions become transparent electrode elements 401.

In the above-mentioned patterning processing, the masking with the shading film is performed so as to form the zigzag structure, in advance. The predetermined masking for the zigzag structure eliminates the accurate alignment for positioning adjustment between the light emitting elements 304, especially between the light emitting elements disposed in the zigzag manner (e.g., between the light emitting elements 304 and 309, and between the light emitting elements 308 and 309).

An organic EL layer 402 is applied on all over the opening surface on which the transparent electrode elements 401 are formed, and on the organic EL layer 402 a metal electrode layer 403 is applied as the common electrode.

In order to seal the light emitting element 304, the resin with the adhesiveness like the epoxy resin is applied on a sealed portion 305 which is a surrounding part of the opening surface of the light transmitting means 302. In the last, the metal electrode layer 403 on the opening surface and the surrounding portion are covered by the sealing glass. In result, the light source 301 is completed.

According to the above steps, the light source 301, wherein the light transmitting means 302 and the light emitting elements 304 are incorporated together, is completed. In the light emitting element 304 thus formed, the organic EL layer 402 sandwiched between the transparent electrode element 401 and the metal electrode layer 403 emits light by applying the electric field on the transparent electrode element 401 and the metal electrode layer 403.

The employment of the organic EL layer and the ingenious patterning processing as described above can solve the structural problem that each element cannot come closer. That is to say, the resolution can be increased moreover by shortening the distance between the elements neighboring in the main scanning direction. And the volume of buffer for the line data can be reduced by shortening the distance between the elements neighboring the sub scanning direction. In addition, it does not make a requisition for the accurate alignment for the light transmitting means and the accurate alignment for the light emitting elements, which are indispensable steps in the prior art.

Besides, since the light emitting element employing the organic EL is formed directly on the light transmitting means, the light emitted from the light emitting element can be transferred direct to the light transmitting means without passing through layers having no directivity. Therefore, the light with no leakage can reach the photosensitive drum with keeping the sufficient light intensity.

### EMBODIMENT 2

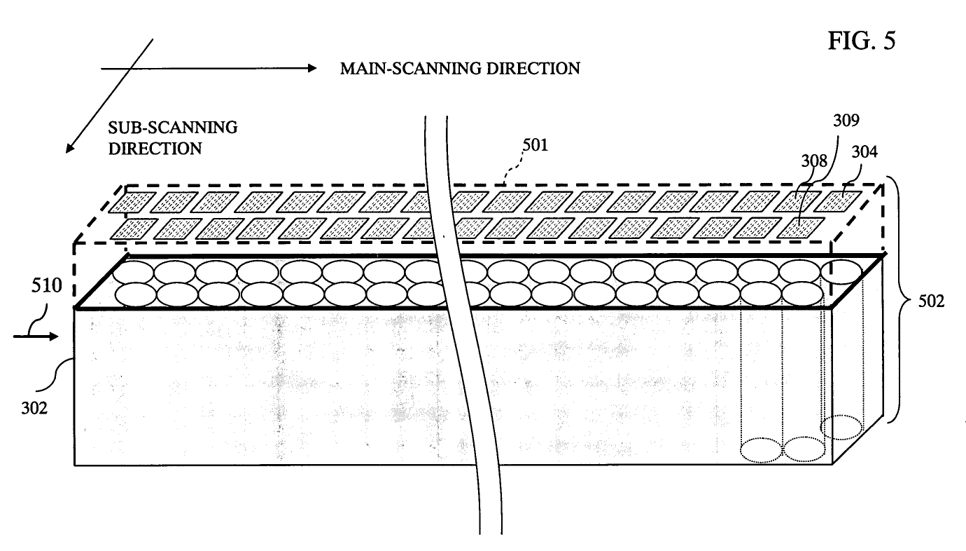

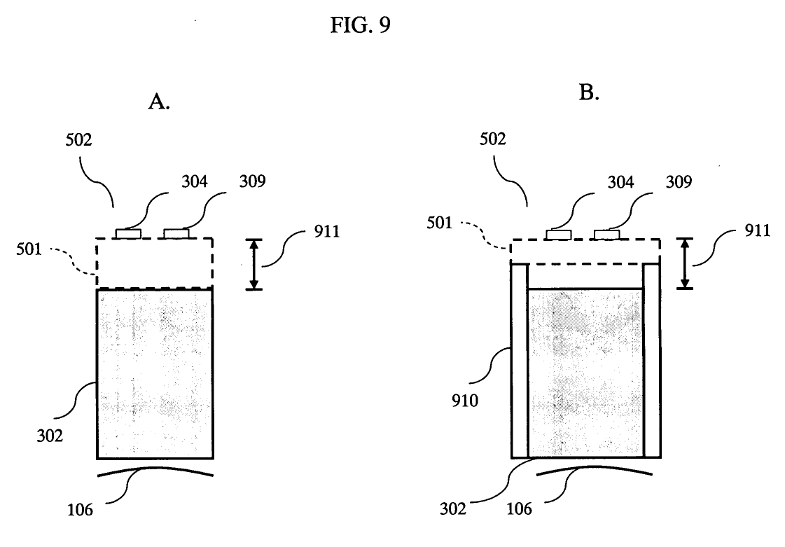

The structure described in Embodiment 1 shows that there is no distance between the light emitting element and the light transmitting means, and such structure corresponds to the light volume transmission that is one of the light transmission methods. The other type of the light transmission method is the image transmission. The difference between the light volume transmission and the image transmission is not described here because such difference has nothing to do with this invention. The image transmission requires the distance (space) between the light emitting element and the light transmitting means, which is different from the light volume transmission. In Embodiment 2, the light source for the image transmission is explained according to FIG. 5 and FIG. 9.

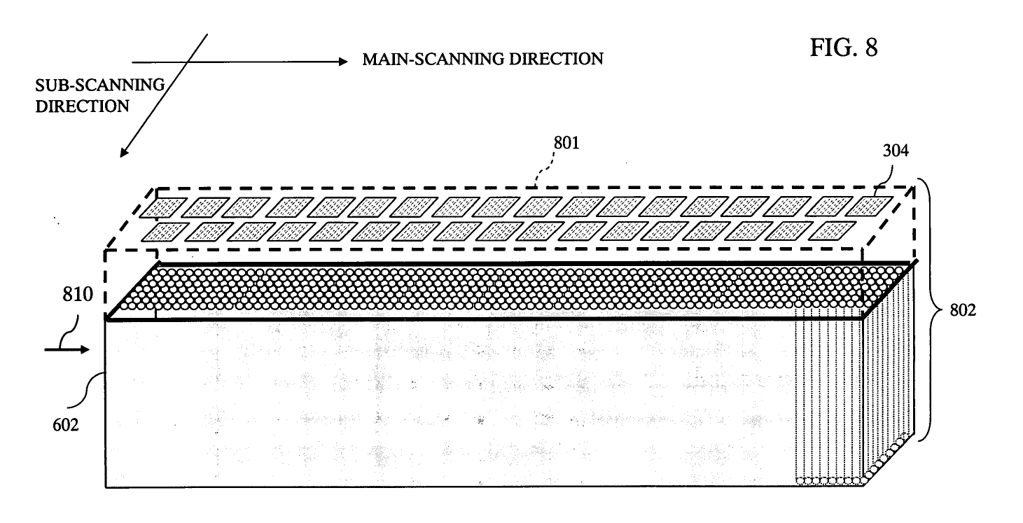

The light source for the image transmission needs the distance between the light emitting element 304 and the light transmitting means 302 as shown in FIG. 5. To provide the distance (space), a transparent substrate 501 is placed, for example. The glass substrate or the transparent resin substrate is used to the transparent substrate. FIG. 9A shows a schematic view of light sources 502 and 802 taken from the direction shown by an arrow 510 in FIG. 5 and the direction shown by an arrow 810 in FIG. 8. The distance 911 between the light emitting element 304 and the light transmitting means 302 is necessary for the image transmission.

The process for forming the light source 502 is explained here. The light transmitting means 302 can use the same light transmitting means as in Embodiment 1. However, the light emitting elements 304 are formed directly on the transparent substrate 501 instead of the light transmitting means in Embodiment 1. The method of forming the light emitting element on the transparent substrate 501 is the same as in Embodiment 1. Specifically, the patterning processing is performed after forming the transparent electrode layer by the application, on which the organic EL layer is applied. And then the metal electrode layer is applied on the organic EL layer.

As a matter of course, the predetermined masking with the shading film is performed so as to form the zigzag structure in the above-mentioned patterning processing, and this eliminates the accurate alignment for the positioning relation between the light emitting elements.

The transparent substrate 501 on which the light emitting elements are disposed, and the light transmitting means 302 are combined into optical piece by adhering them with by the transparent resin, whereby the light source 502 is completed.

By fixing the distance between the light emitting element and the light transmitting means by means of the thickness of the substrate as described above, it is possible to obtain the necessary distance for the image transmission. At this time, the light emitting elements are formed on the substrate, and the distance is based on the thickness of the substrate, with the result that the distance between the light emitting element 304 and the photosensitive drum 106 is identical with the distance between the light emitting element 309 and the photosensitive drum 109, without any tolerance. Therefore, it is possible to obtain a clear latent image on the photosensitive drum.

Besides, a fixing frame 910 for fixing the distance between the light emitting element and the light transmitting means may be adhered to the light transmitting means 302 and the transparent substrate 501, for example, so that the distance between the light emitting element and the light transmitting means could be fixed. Even in such case, since the light emitting elements are formed on the substrate, and the light emitting elements and the light transmitting means are combined together, the distance between the light emitting element and the photosensitive drum can be fixed at a constant value.

It is nevertheless to say that the alignment for the light emitting elements and the alignment for the single lenses are eliminated.

### EMBODIMENT 3

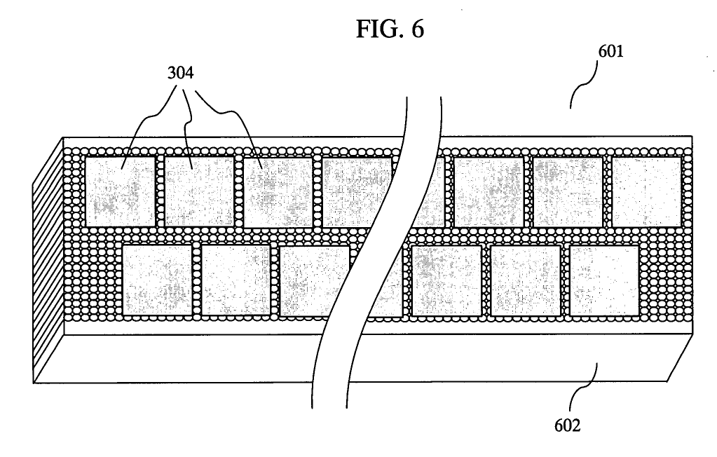

The following explanation relates to a structure of the light source 200 (light source 601 in FIG. 6) wherein each size of the single lenses of the light transmitting means are smaller than the light emitting element 304.

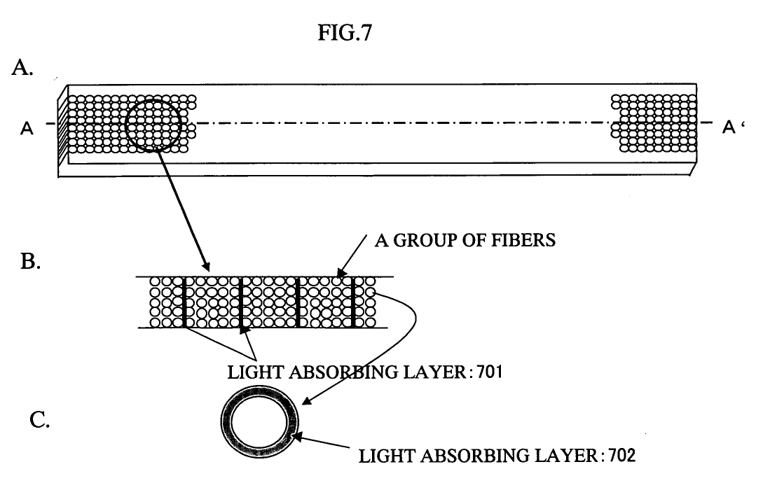

In the light source 601 in FIG. 6, the light emitting elements are formed on the light transmitting means 602. Each single lens of the light transmitting means 602 has a diameter smaller than the side length of the light emitting element 304, as shown in FIG. 7A. That it is to say, one of the light emitting elements 304 corresponds to a plurality of single lenses.

The single lenses of the light transmitting means are grouped per a plurality or a specific number, and light absorbing layers 701 are provided to each group, as shown in FIG. 7B. Otherwise, each single lens is surrounded by a light absorbing layer 702, as shown in FIG. 7C.

On the light transmitting means 602 thus formed, the light emitting elements 304 may be placed. The method of forming the light emitting elements 304 directly on the light transmitting means 602 is the same as in Embodiment 1.

Under such configuration, the diameter of the single lens is smaller than the side length of the light emitting element 304, so that the light emitting elements can be formed regardless of the delicate positioning relation between the light emitting element and the single lens. And this facilitates the production of the light source.

Specifically, by designing that the diameter of the single lens is made small, and one of light emitting elements is made to correspond to a plurality of single lenses, the accurate alignment can be eliminated. Consequently, the light source can be produced without the accurate alignment for the light emitting elements as well as the accurate alignment for the single lenses, as described in Embodiments 1 and 2. Therefore, as well as the above-mentioned production method can reduce the production cost, the quality of the produced light source can be kept high. On the other hand, if the diameter of the single lens is made large and a plurality of light emitting elements is made to correspond to one of single lenses, the positioning adjustment between the light emitting element and the light transmitting means is not necessary to be accurate in the same way as above. And the alignment for the light emitting elements and the alignment for the single lenses are not necessary to be accurate, too.

Besides, when the light source for the image transmission described in Embodiment 2 is formed so as to be adaptive to Embodiment 3, the structure is described hereinafter according to FIG. 8. In the same way as Embodiment 2, a transparent substrate 801 is provided on the light transmitting means 602. On the transparent substrate 801 thus formed, each light emitting element 304 is disposed in the zigzag manner. The method of forming the light emitting elements 304 and the material of the transparent substrate 801 are the same as the afore-mentioned embodiment.

Next, the transparent substrate 801 on which the light emitting elements are disposed, and the light transmitting means 602 are integrated in optical one piece by means of the transparent resin, whereby the light source 802 is completed.

### INDUSTRIAL APPLICABILITY

The light source for the image writing apparatus and the production method of the light source in the invention make it possible to increase the resolution more by reducing the distance between adjacent elements in the main scanning direction, and also to reduce the buffer for the line data by reducing the distance between adjacent elements in the sub scanning direction. The accurate alignment for the light transmitting means and the accurate alignment for the light emitting elements are indispensable steps in the conventional method, but the invention does not require such steps.

In addition, the distance between the light emitting element and the light transmitting means is fixed by the thickness of the substrate, so that the necessary distance for the image transmission can be obtained. At this time, the light emitting elements are formed on a substrate, and the distance is fixed by the thickness of the substrate, whereby a clear latent image can be formed on the photosensitive drum.

Moreover, the diameter of the single lens is made small, and a light emitting element is made to correspond to a plurality of single lenses, whereby it is possible to produce the light source without the accurate alignment for the light emitting element and the light transmitting means, the alignment for the light emitting elements, and the alignment for the single lenses. According to such production method, not only the production cost can be reduced, but also the quality of the produced light source can be kept high.

Therefore, the invention is available for the light source for the image writing apparatus for an image with the high resolution, and the production method for the light source.

1. A light source for an image writing apparatus for focusing light emitted from light emitting elements provided on a specific substrate on a photosensitive drum and forming an image thereon, said light source wherein
the light emitting elements are disposed on the substrate in a zigzag manner.

2. The light source according to claim 1, wherein the light emitting element comprises an organic electro luminescence.

3. The light source according to claim 2, wherein the substrate is a light transmitting means for focusing light emitted from the light emitting elements on the photosensitive drum and forming an image thereon.

4. The light source according to claim 2, wherein the light transmitting means for focusing light emitted from the light emitting element on the photosensitive drum and forming an image thereon is formed on an opposite surface to the light emitting elements of the substrate so as to be incorporated together.

5. The light source according to claim 4, wherein the distance between the light emitting element and the light transmitting means is fixed by a thickness of the substrate.

6. The light source according to claim 4, wherein the distance between the light emitting element and the light transmitting means is fixed by a fixing frame for fixing the distance between the light emitting element and the light transmitting means.

7. The light source according to claim 3, wherein the light transmitting means is a lens alley comprising a plurality of single lenses.

8. The light source according to claim 7, wherein one of the light emitting

8. The light source according to claim 7, wherein one of the light emitting elements is made to correspond to one of the single lenses.

9. The light source according to claim 7, wherein one of the light emitting elements is made to correspond to a plurality of the single lenses.

10. The light source according to claim 7, wherein a plurality of the light emitting elements is made to correspond to one of the single lenses.

11. A method of producing a light source for an image writing apparatus for focusing light emitted from light emitting elements on a photosensitive drum and forming an image thereon, said method comprising the steps of:
forming a transparent electrode layer directly on a specific substrate;
forming the transparent electrode layer into a plurality of transparent electrodes with a zigzag structure by means of a specific patterning processing;
forming a light emitting layer comprising an organic electro luminescence on the respective transparent electrodes with the zigzag structure; and
forming a metal electrode layer on the light emitting layer.

12. The method of producing the light source according to claim 11, wherein the transparent electrode is an Indium-Tin Oxide electrode.

13. The light source according to claim 4, wherein the light transmitting means is a lens alley comprising a plurality of single lenses.

14. The light source according to claim 13, wherein one of the light emitting elements is made to correspond to one of the single lenses.

15. The light source according to claim 13, wherein one of the light emitting elements is made to correspond to a plurality of the single lenses.

16. The light source according to claim 13, wherein a plurality of the light emitting elements is made to correspond to one of the single lenses.
